(19) United States
(12) Patent Application Publication
(10) Pub. No.: US 2023/0401661 A1
(43) Pub. Date: Dec. 14, 2023

(54) DIGITAL PLATFORM ASSET MANAGEMENT

(71) Applicant: LoginLegacy Inc., San Diego, CA (US)

(72) Inventors: Logan LACHER, San Diego, CA (US); Jake BRADLEY, San Diego, CA (US)

(21) Appl. No.: 18/026,783

(22) PCT Filed: Sep. 16, 2021
(86) PCT No.: PCT/US2021/050720

§ 371 Date: Mar. 16, 2023

Related U.S. Application Data
(60) Provisional application No. 63/079,058, filed on Sep. 16, 2020.

(51) Int. Cl. G06Q 50/18; G06Q 50/00

(52) U.S. Cl. CPC G06Q 50/186; G06Q 50/01

(57) ABSTRACT

Digital platform asset management allows a person to prepare and posthumously execute a plan for winding down of digital assets upon the death of the person. A digital platform asset management system receives username, password, and instruction combinations that correspond to the digital accounts of a person. The system determines an account type for each digital account and validates the instruction in accordance with the account type. Upon receipt and validation of a death certificate for the person, the system identifies the various username, password, and instruction combinations and executes each instruction on the corresponding digital account. The instructions may include one or more of delete, download, memorialize, transfer ownership, and sanitize. While the person remains alive, the system periodically validates the various digital accounts and proactively searches for new digital accounts associated with the person.

### BACKGROUND

### Field of the Invention

The embodiments described herein are generally directed to online personas and digital assets and more particularly, to posthumous management of online personas and digital assets.

### Description of the Related Art

Online accounts and digital personas have exploded over the last two decades and users typically have many digital accounts that extend across many third party digital platforms. Social media is one category of digital platform (e.g., Facebook, LinkedIN, Snapchat, etc.) and in addition to social media there are many other types of digital platforms such as digital asset storage platforms (Dropbox, OneDrive, GoogleDrive, etc.) and digital service provider platforms (e.g., Soundcloud, Spotify, etc). Typical users may have many digital accounts on a single digital platform and generally also have a digital account on several different platforms. When a user passes away, these digital accounts typically atrophy and may remain as inaccessible and painful reminders to loved ones of the deceased person.

Winding down such digital accounts is a logistical and legal mess. Each digital platform provider has its own soulless policies that control how such digital accounts are attended to after the death of an account owner. There are significant problems associated with closing, consolidating, memorializing, and/or deleting a deceased individual's online personas and digital accounts.

As it stands today, a family member or loved one typically attempts to wind down a deceased person's online personas and digital accounts. Those representatives may or may not know how many digital accounts were owned by the deceased person and what the corresponding usernames and passwords are. More typically, these representatives generally do not have access to usernames and passwords and are therefore must follow the cumbersome and confusing corporate policies for gaining access to the accounts. These policies generally are in place for the benefit of the corporation and do not follow the wishes of the deceased person. Such policies typically require the representative of the deceased to provide a death certificate before being allowed to gain access to and thereby close the account. Moreover, these representatives are usually limited in what they can do with the deceased person's digital account and are most often only able to delete the deceased person's account, although a growing number of digital platforms are starting to allow for memorization of a deceases person's account.

Finally, whoever the deceased person's representative is, that person is typically unprepared to make decisions about how to wind down the deceased person's digital assets. However, it is extremely uncommon for a deceased person's will to identify how to wind down such digital assets. This makes the current situation surrounding digital platform asset management for deceased persons extremely time consuming and emotionally draining. Accordingly, what is needed is a solution that addresses the significant problems identified above.

### SUMMARY

Accordingly, systems, methods, and non-transitory computer-readable media are disclosed to enable a person to prepare and posthumously execute a plan for winding down of digital assets upon the death of the person.

In one aspect, a digital platform asset management system receives username, password, and instruction combinations that correspond to the digital accounts of a person. The system determines an account type for each digital account and validates the instruction in accordance with the account type. Upon receipt and validation of a death certificate for the person, the system identifies the various username, password, and instruction combinations and executes each instruction on the corresponding digital account. The instructions may include one or more of delete, download, memorialize, transfer ownership, and sanitize. Advantageously, downloading may preserve invaluable digital assets such as photographs and videos and writings and music created by the person and the transfer of ownership may convey valuable income producing digital assets to individuals selected by the person prior to death.

While the person remains alive, the system periodically validates the various digital accounts and proactively searches for new digital accounts associated with the person. The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example process for planning digital platform asset management according to an embodiment; and

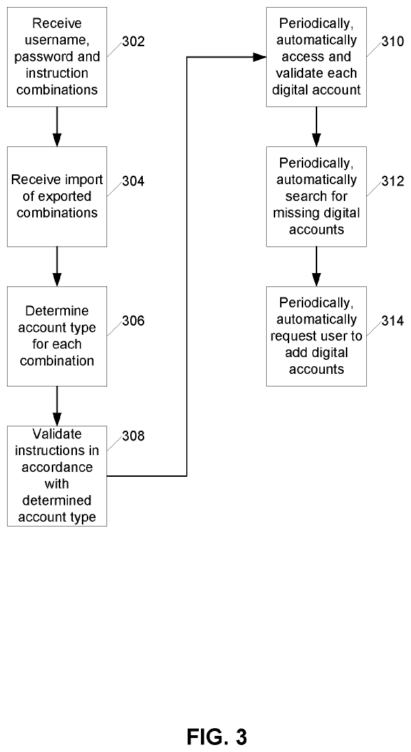

FIG. 4 illustrates an example process for executing digital platform asset management, according to an embodiment.

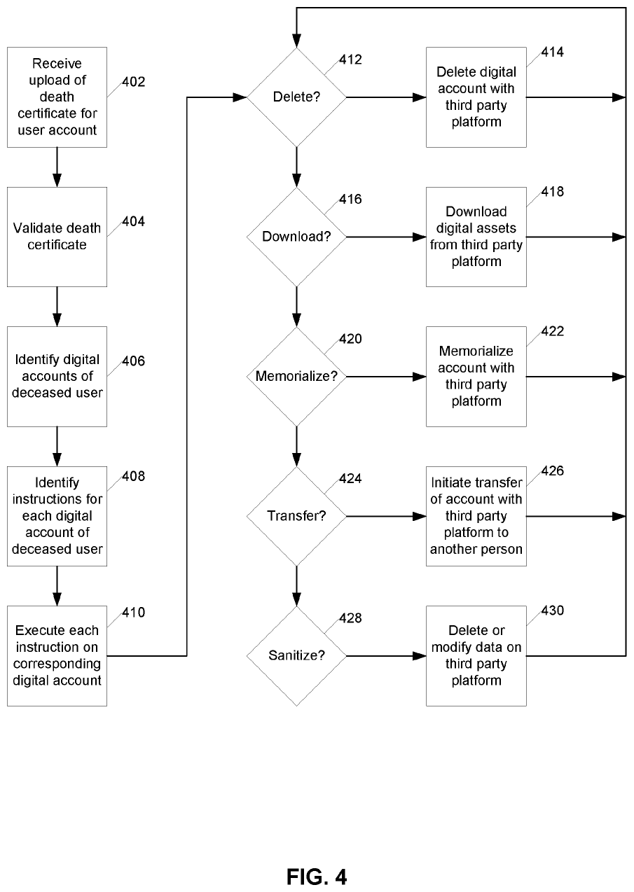

### DETAILED DESCRIPTION

In an embodiment, systems, methods, and non-transitory computer-readable media are disclosed that permit a person to prepare and posthumously execute a plan for winding down of digital assets owned by the person upon the death of the person.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

1.1. Infrastructure

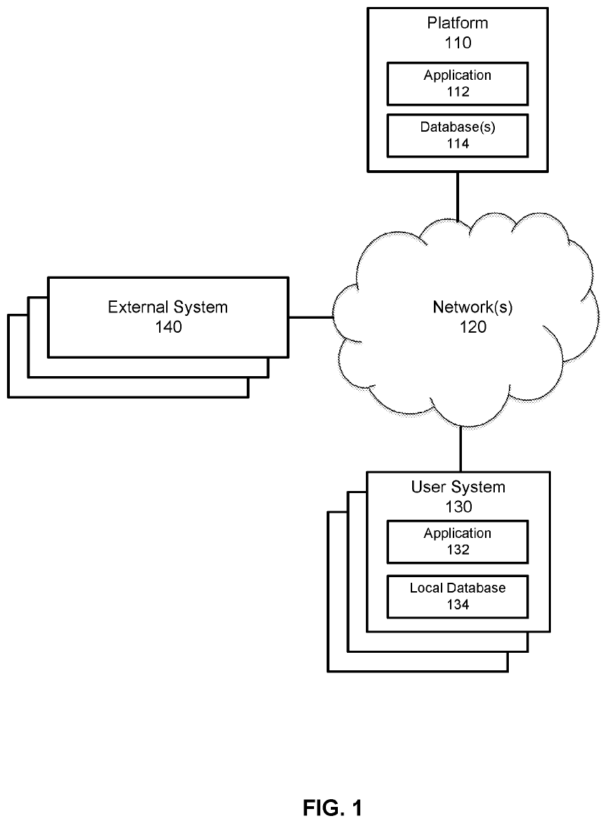

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

In one aspect, the platform 110 comprises one or more servers that host one or more applications 112 that allow a user to gain access to the platform 110 via the network 120 from user system 130 and create accounts for digital platform asset management. A user provides one or more combinations of user name, password, and instruction and the application 112 validates and saves these combinations, where each combination corresponds to a third party digital account, for example, hosted on an external system 140. During the life of the user, the platform 110 periodically and automatically accesses each third party digital account to validate the username and password combination. The platform 110 also periodically and automatically proactively searches for username and password combinations corresponding to third party digital accounts of the user that have not been provided by the user and validated and stored by the platform 110. For example, the platform 110 may do this by accessing one or more single sign-on services of the user and comparing a list of third party digital accounts maintained by the single sign-on service to the set of username and password combinations stored in platform 110. Such single sign-on services may include, e.g., Google, Apple, Facebook, and the like. The platform 110 also periodically and automatically contacts the user to provide a summary of existing username and password and instruction combinations and to request that the user provide the username and password and instruction for any missing or additional third party digital accounts of the user.

In one aspect, the platform 110 may cooperate with an application 132 that executes on the user system 130. For example, the user system 130 may be a wireless communication device such as a cell phone and the application 132 may be downloaded and installed on the user system 130. When executed, the application 132 may communicate with the platform 110 and use a combination of data stored in local database 134 and data received from platform 110 to interact with the user and provide functionality to allow the user to manage digital platform assets.

1.2. Example Processing Device

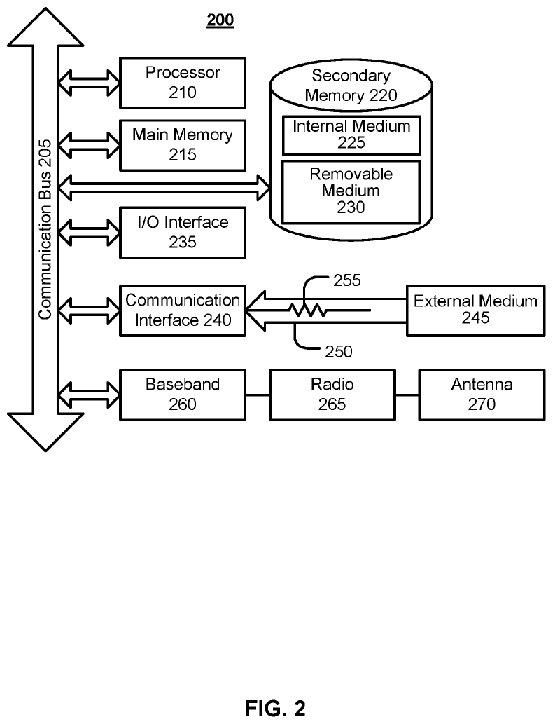

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, wireless communication device, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter di splays (SEDs), field emission di splays (FED s), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

### 2. Process Overview

Embodiments of processes for digital platform asset management will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

2.1. Planning Digital Platform Asset Management

Initially at 302 the system is configured to receive one or more combinations of username, password, and instruction. Each of the combinations corresponds to a digital account owned by the user. The digital account is typically associated with a third party digital platform such as Facebook, LinkedIN, GoogleDocs, OneDrive, Dropbox, Soundcloud, and the like. Other types of digital accounts may also be included such as YouTube, Amazon, eBay, and other ecommerce platforms. In one aspect, at 304 the system may receive an import of one or more exported username and password combinations. For example, online digital password management utilities can export a set of usernames and passwords and these can be imported into the system. Advantageously, the system is configured to require that each combination include an instruction so for any username and password combinations that are imported, the system is configured to prompt the user to identify one or more instructions to be associated with the combination.

At 306 the system determines an account type for each combination. This allows the system to determine a set of valid instructions that can be associated with the underlying third party digital platform. In this manner, the system can validate the username and password and instruction combinations, as shown at 308. In one aspect, the username and password portion of combinations for different digital accounts may be identical. This may be true when the user has taken advantage of a single sign-on services such as provided by the likes of Google, Apple, Facebook and other third party platform services providers. Other combinations for other digital accounts may have unique username and password portions of their respective combinations, for example, when a single sign-on service is not employed by the user for that third party platform service.

At 310, the system periodically and automatically uses the username and password combinations to access the third party digital platform and login to periodically validate each of the username and password and instruction combinations associated with the user account. Advantageously, the system is also configured to periodically and automatically access one or more digital accounts of the user to search for any missing digital accounts that are not included in the system as shown at 312. For example, the user may have one or more single signon accounts and the system periodically accesses these accounts and compares the set of username and password combinations maintained by the single signon account with the set of username and password and instruction combinations maintained by the system. If the single signon account includes any additional digital accounts, the system is configured to prompt the user to add the corresponding username and password and instruction combinations to the system. At 314, the system periodically and automatically contacts the user to request that any additional or missing digital accounts be added. For example, the system may periodically (e.g., monthly or quarterly) proactively contact (e.g., via email) the user and provide a summary of the digital accounts that are included and request that the user add any digital accounts that may be missing. In this fashion, the system is configured to automatically and continuously be updated with all of the digital accounts owned by the user.

2.2. Executing Digital Platform Asset Management

Initially at 402, the system is configured to receive an upload of a death certificate corresponding to a user of the system. The system is configured to validate the death certificate at 404 and subsequently at 406 identify one or more digital accounts of the deceased user. Each of the one ore more digital accounts has a combination of username and password and instruction, where the instruction may include one or more instructions.

At 408 the system identifies the one or more instructions corresponding to each digital account of the deceased user and at 410 the system executes each of the one or more instructions on the corresponding digital account of the deceased user.

If the instruction is to delete, as determined at 412, at 414 the system initiates deleting of the account with the third party digital platform. If the instruction is to download, as determined at 416, at 418 the system initiates downloading of one or more digital assets from the digital account at the third party digital platform. The one or more digital assets are downloaded to a predetermined data storage location that may be part of the system or may be part of another third party platform and associated with an account of a third party previously designated by the deceased user. If the instruction is to memorialize, as determined at 4120, at 422 the system initiates memorializing of the account with the third party digital platform. If the instruction is to transfer, as determined at 424, at 426 the system initiates transfer of legal ownership of the digital account at the third party platform to a third party previously designated by the deceased user.

If the instruction is to sanitize, as determined at 428, at 430 the system accesses the digital account and analyzes the content in the digital account. Advantageously, the system includes an artificial intelligence (AI) based sanitation engine that is configured to analyze digital content to identify private content and/or objectionable, explicit, or otherwise undesirable content in text, audio, video and still images. The sanitation engine may be implemented as an application 112 from FIG. 1. The sanitation engine is configured to operate in connection with one or more parameters that are predetermined by the deceased user. Accordingly, the system, by way of the sanitation engine, is configured to analyze digital content and selectively delete and/or modify digital content associated with the user account in accordance with the desires of the deceased user. This may be done, for example, prior to memorializing the digital account or prior to downloading the digital account, or prior to transferring ownership of the digital account and even before deleting the digital account.

Advantageously, execution of each of the instructions may be combined with execution of other instructions and the system is configured to appropriately prioritize and implement the various instructions such that, for example, the digital account is sanitized before it is memorialized. Furthermore, the sanitation engine is configured to continuously learn from its analysis of digital content and improve it ability to identify private material and/or objectionable material in accordance with increasingly sophisticated and nuanced parameters that are predetermined by deceased users.

### 3. Example Embodiments

In one aspect, a method for digital platform asset management includes a number of steps that are carried out by a digital platform such as platform 110. For example, the platform 110 is configured to receive a plurality of username and password and instruction combinations and store the plurality of username and password and instruction combinations in association with a user account on the platform 110. Advantageously, each of the plurality of username and password and instruction combinations corresponds to a digital account owned by the owner of the user account. The digital accounts typically correspond to third party digital platforms. The platform 110 is also configured to determine an account type for each digital account corresponding to a username and password and instruction combination and validate the instruction in accordance with the account type of the digital account. For example, some third party digital platforms allow a digital account to be memorialized and others do not. Accordingly, validation can include confirming for any “memorialize” instructions that the third party digital platform does in fact allow memorialization.

The digital accounts from the third party digital platforms are each accessible via one or more computer networks. In one aspect, the platform 110 may receive at least a portion of the plurality of username and password and instruction combinations via an import of exported data comprising a plurality of username and password combinations. For example, a digital platform such as LastPass may export a set of username and password combinations for the user and this data export may be imported into the platform 110.

The instruction that is part of the username and password and instruction combination can include a variety of instructions such as delete, download, memorialize or transfer ownership. When executed, the delete instruction will delete the digital account, the download instruction will download digital assets from the digital account to a predetermined location for storing digital assets, the memorialize instruction will cause the third party digital platform to memorialize the digital account, e.g., for a desired time period, and may also implement a desired notification for indicating that the owner of the digital account is deceased. Also when executed, the transfer ownership instruction will initiate transfer of legal ownership of the digital account to an identified a third party desired by the user to receive legal ownership of the digital account.

In an aspect, the instruction may also include a sanitize instruction, which may itself include one or more sanitation levels. Executing the sanitize instruction will cause the platform 110 to edit content on the digital account to delete or edit data that is objectionable in some fashion, e.g., explicit or controversial, or data that has been designated as private by the user.

The platform 110 is also configured to periodically and automatically access each digital account via one or more computer networks using the corresponding username and password to validate the respective digital account and successful access to the respective digital account. If access is prevented, the platform 110 is configured to notify the user so that the username and password combination can be updated or deleted. The platform 110 is also configured to periodically and automatically access at least one digital account of the owner of the user account to identify the existence of one or more additional digital accounts of the owner of the user account that are not included in the plurality of username and password and instruction combinations. For example, the platform 110 may access a single signon account of the user and compare the plurality of username and password and instruction combinations to the set of username and password combinations in the single signon account. If the single singon account has additional username and password combinations the platform 110 is configured to request that the user add or import these additional accounts and upon adding or importing, the platform 110 is configured to require the user to also add an instruction so that each digital account has a username and password and instruction combination.

In another aspect, after the user dies, the platform 110 is configured to receive an upload of a death certificate and validate that the death certificate corresponds to the owner of the user account. The platform 110 is also configured to identify a plurality of username and password and instruction combinations associated with the user account, where each username and password combination corresponds to a third party platform digital account of the owner of the user account. The platform is also configured to execute each instruction on the corresponding digital account. The instructions for each digital account may include one or more of deleting, downloading, memorializing, sanitizing and transferring ownership of the digital account.

If the instruction is delete, the platform 110 is configured to delete the digital account. If the instruction is download, the platform 110 is configured to download digital assets from the digital account to a predetermine location for storage. If the instruction is memorialize, the platform 110 is configured to initiate memorializing the digital account on the third party platform. Any of these instructions may also be combined with a sanitize instruction, and if the instruction is sanitize the platform 110 is configured to edit the digital account to delete or modify objectionable or private data in accordance with the desires of the deceased account owner. If the instruction is transfer ownership, the platform 110 is configured to initiate a legal ownership transfer from the deceased person to third party.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1. A method comprising using at least one hardware processor to:
receive a plurality of username and password and instruction combinations and store the plurality of username and password and instruction combinations in association with a user account, wherein each of the plurality of username and password and instruction combinations corresponds to a digital account of an owner of the user account;
determine an account type for each digital account corresponding to a username and password and instruction combination; and
validate the instruction in accordance with the account type of the digital account, wherein each instruction comprises one of delete, download, memorialize or transfer ownership and the download instruction further comprises a destination for storing one or more digital assets.

2. The method of claim 1, wherein each digital account is accessible via one or more computer networks.

3. The method of claim 1, wherein at least a portion of the plurality of username and password and instruction combinations is received via an import of exported data comprising a plurality of username and password combinations.

4.-5. (canceled)

6. The method of claim 1, wherein the memorialize instruction further comprises one of a time period and a type of notification for indicating that the owner of the digital account is deceased.

7. The method of claim 1, wherein the transfer ownership instruction further comprises an identification of a third party to receive legal ownership of the digital account.

8. The method of claim 1, wherein an instruction further comprises a sanitize instruction, wherein the sanitize instruction comprises one or more sanitation levels.

9. The method of claim 1, further comprising:
periodically and automatically accessing each digital account via one or more computer networks using the corresponding username and password to validate the respective digital account; and
periodically and automatically accessing at least one digital account of the owner of the user account to identify one or more digital accounts of the owner of the user account not included in the plurality of username and password and instruction combinations.

10. A method comprising using at least one hardware processor to:
receive an upload of a death certificate identifying a deceased person corresponding to an owner of a user account;
validate the death certificate and correspondence between the deceased person and the owner of the user account;
identify a plurality of username and password and instruction combinations associated with the user account, wherein each username and password combination corresponds to a digital account of the owner of the user account; and
executing each instruction on the corresponding digital account.

11. The method of claim 10, wherein executing each instruction comprises one of deleting, downloading, memorializing or transferring ownership of the digital account.

12. The method of claim 11, wherein deleting comprises deleting the digital account.

13. The method of claim 11, wherein downloading comprises downloading one or more digital assets from the digital account.

14. The method of claim 11, wherein memorializing comprises adding an indication to the digital account that the owner of the digital account is deceased.

15. The method of claim 14, wherein memorializing further comprises preventing edits to the digital account.

16. The method of claim 11, wherein transferring ownership further comprises initiating a legal ownership transfer from the deceased person to third party.

17. The method of claim 11, wherein executing each instruction further comprises sanitizing the digital account.

18. The method of claim 16, wherein sanitizing further comprises selectively deleting or modifying explicit, controversial, or private data.

19. A system comprising:
at least one hardware processor; and
one or more software modules that are configured to, when executed by the at least one hardware processor,
receive a plurality of username and password and instruction combinations and store the plurality of username and password and instruction combinations in association with a user account;
determine an account type for each username and password and instruction combination; and
validate the instruction in accordance with the account type, wherein each instruction comprises one of delete, download, memorialize or transfer ownership and the download instruction further comprises a destination for storing one or more digital assets.

20. (canceled)

21. A system comprising:
at least one hardware processor; and
one or more software modules that are configured to, when executed by the at least one hardware processor,
receive an upload of a death certificate identifying a deceased person corresponding to an owner of a user account;
validate the death certificate and correspondence between the deceased person and the owner of the user account;
identify a plurality of username and password and instruction combinations associated with the user account, wherein each username and password combination corresponds to a digital account of the owner of the user account; and
executing each instruction on the corresponding digital account.

22. (canceled)
